(19) United States
(12) Patent Application Publication
(10) Pub. No.: US 2022/0292059 A1
(43) Pub. Date: Sep. 15, 2022

(54) INFORMATION PROCESSING APPARATUS, NON-TRANSITORY COMPUTER READABLE MEDIUM STORING PROGRAM, AND INFORMATION PROCESSING METHOD

(71) Applicant: FUJIFILM Business Innovation Corp., Tokyo (JP)

(72) Inventor: Takumi TANAKA, Kanagawa (JP)

(73) Assignee: FUJIFILM Business Innovation Corp., Tokyo (JP)

(21) Appl. No.: 17/404,990

(22) Filed: Aug. 17, 2021

(30) Foreign Application Priority Data
Mar. 9, 2021 (JP) 2021-037712

(51) Int. Cl. G06F 16/16; G06F 3/0484; G06F 3/0481; G06F 3/0488

(52) U.S. Cl. CPC G06F 16/168; G06F 3/04842; G06F 3/04817; G06F 3/04886; G06F 3/04845

(57) ABSTRACT

An information processing apparatus includes a processor configured to in a case where an image related to a file or a thumbnail image corresponding to the file is selected and an enlarged thumbnail image obtained by enlarging the thumbnail image is displayed in a first peripheral area which is a peripheral area of the image related to the file or the thumbnail image, move the image related to the file or the thumbnail image in a case where the first peripheral area is smaller than a predetermined value, and display the enlarged thumbnail image in a second peripheral area which is a peripheral area of the image related to the file or the thumbnail image after the movement.

### CROSS-REFERENCE TO RELATED APPLICATIONS

This application is based on and claims priority under 35 USC 119 from Japanese Patent Application No. 2021-037712 filed Mar. 9, 2021.

### BACKGROUND

### (i) Technical Field

The present invention relates to an information processing apparatus, a non-transitory computer readable medium storing a program, and an information processing method.

### (ii) Related Art

JP2015-032091A describes a configuration in which in a case where a designated file is displayed on a display screen of an information processing apparatus, the display screen is divided into two and windows are generated side by side not to be superimposed on each other, the original screen is displayed in one window, and a file to be operated is displayed in the other window.

JP2010-102720A describes a configuration in which in a case where a window is enlarged or reduced, a set of curves connecting first and second window positions is defined, and changing of a scaling and the position of a first window is repeated so that the first window is moved to slide between this curve from the first window position to the second window position.

### SUMMARY

In a case where an image related to the file or a thumbnail image corresponding to the file such as an icon is selected, a thumbnail image obtained by enlarging the thumbnail image may be displayed in a peripheral area which is a peripheral area of the image related to the file or the thumbnail image. In this case, in a case where the image or the thumbnail image related to the file is located in a center or the like on the display screen, the peripheral area becomes smaller, and the enlarged thumbnail image displayed in the peripheral area also becomes smaller, so that it becomes difficult for a user to confirm the enlarged thumbnail image.

Aspects of non-limiting embodiments of the present disclosure relate to an information processing apparatus, a non-transitory computer readable medium storing a program, and an information processing method that display, in a case where an image related to a file or a thumbnail image corresponding to the file is selected and a thumbnail image obtained by enlarging the thumbnail image is displayed in a peripheral area which is a peripheral area of the image related to the file or the thumbnail image, the thumbnail image to be larger than in a case where the image related to the file or the thumbnail image is moved and the peripheral area is not changed.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus including a processor configured to in a case where an image related to a file or a thumbnail image corresponding to the file is selected and an enlarged thumbnail image obtained by enlarging the thumbnail image is displayed in a first peripheral area which is a peripheral area of the image related to the file or the thumbnail image, move the image related to the file or the thumbnail image in a case where the first peripheral area is smaller than a predetermined value, and display the enlarged thumbnail image in a second peripheral area which is a peripheral area of the image related to the file or the thumbnail image after the movement.

### BRIEF DESCRIPTION OF THE DRAWINGS

Exemplary embodiment(s) of the present invention will be described in detail based on the following figures, wherein:

FIG. 1 is a block diagram illustrating an example of a hardware configuration of an image display apparatus according to the present exemplary embodiment;

FIG. 2 is a diagram illustrating an example of displaying an operation screen;

FIG. 3 is a block diagram illustrating an example of a functional configuration of the image display apparatus;

FIG. 4 is a flowchart illustrating a processing procedure of displaying an enlarged thumbnail image;

FIGS. 5A and 5B are diagrams illustrating an example of displaying an operation screen;

FIG. 6 is a flowchart illustrating a processing procedure of displaying a selection screen according to movement;

FIG. 7 is a flowchart illustrating a processing procedure of displaying the enlarged thumbnail image without displaying the selection screen; and

FIGS. 8A and 8B are diagrams illustrating an example of a screen for requesting an instruction to a user.

### DETAILED DESCRIPTION

Hereinafter, exemplary embodiments of the present invention will be described in detail with reference to drawings.

Hardware Configuration of Image Display Apparatus 1

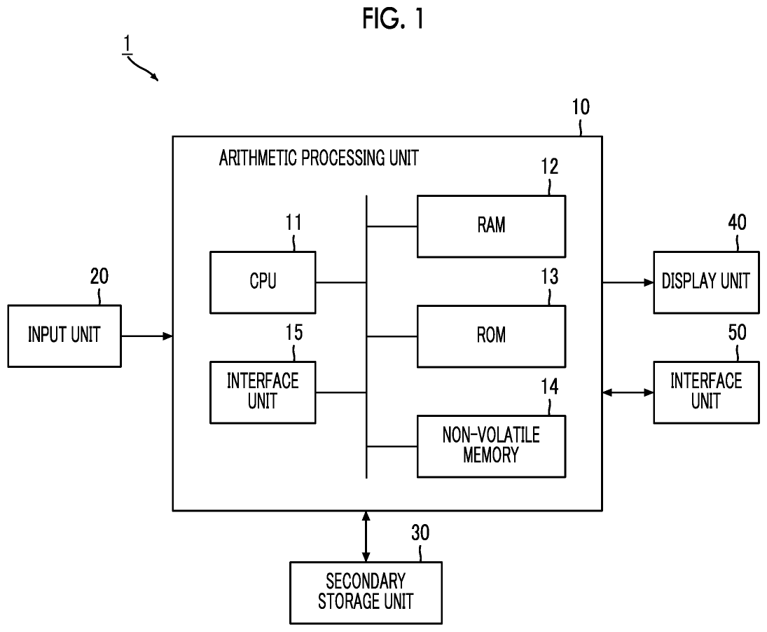

FIG. 1 is a block diagram illustrating an example of a hardware configuration of an image display apparatus 1 according to the present exemplary embodiment. The image display apparatus 1 according to the present exemplary embodiment functions as an example of an information processing apparatus, and includes an arithmetic processing unit 10 that executes a digital arithmetic process according to a predetermined processing program in a case of displaying an image, an input unit 20 such as a keyboard, a pointing device, a touch panel, or the like that accepts an input operation from a user, a secondary storage unit 30 that is realized by, for example, a hard disk drive (HDD) in which image data such as document data is recorded, a display unit 40 that consists of a liquid crystal display panel, an organic electro luminescence (EL) display panel, or the like which displays an image, text information, or the like to the user, and a communication unit 50 which transmits and receives data via a network.

The arithmetic processing unit 10 includes a CPU 11 that controls the entire apparatus, as an example of a processor, a RAM 12 to be used as a working memory of the CPU 11, a ROM 13 that stores an image display processing program or the like executed by the CPU 11, a non-volatile memory 14 such as an SRAM, a flash memory, or the like backed up by battery, that is rewritable and can hold data even in a case where power supply is interrupted, and an interface unit 15 that controls each unit such as the input unit 20 connected to the arithmetic processing unit 10. Image information of a thumbnail image displayed on the display unit 40 is stored in the non-volatile memory 14.

In addition to storing image data and the like, the secondary storage unit 30 also stores an image display processing program to be executed by the arithmetic processing unit 10, and the arithmetic processing unit 10 reads the image display processing program to execute each process of the image display apparatus 1 according to the present exemplary embodiment.

Here, the program executed by the CPU 11, as an example of a processor, is provided to the arithmetic processing unit 10 in a state of being stored in a computer-readable recording medium such as a magnetic recording medium (a magnetic tape, a magnetic disk, or the like), an optical recording medium (an optical disk, or the like), an optical magnetic recording medium, a semiconductor memory, or the like. Further, the program executed by the CPU 11 may be downloaded to the image display apparatus 1 by using a communication section such as the Internet.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

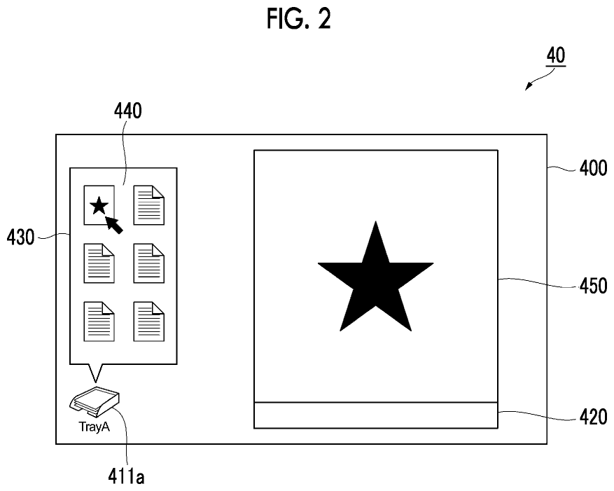

FIG. 2 is a diagram illustrating an example of displaying an operation screen.

The display unit 40 includes an operation screen 400 that displays an icon 410 such as an image or a thumbnail image related to a file selected by the user, as illustrated in FIG. 2. The icon 410 represents a program function or various types of functions of a file or the like with pictograms. In the example illustrated in FIG. 2, a tray icon 411a is illustrated as an example of the icon 410. The operation screen 400 is a workspace on document handling software. The document handling software is software that digitizes and manages document data, and has a function of promoting unified management of paper and electronic files.

In the exemplary embodiments of the present invention, the “file” includes a tray used for the user to exchange an electronic document with a third party, a folder used for storing the electronic document, the electronic document, and the like.

In addition to the icon 410, a toolbar 420, a selection screen 430, a thumbnail image 440, and an enlarged thumbnail image 450 are displayed on the operation screen 400. The tray icon 411a, which is an example of the icon 410, is an image for selecting a tray. The toolbar 420 is an aggregation of instruction units prepared to simplify operations on electronic documents by the user. Examples of the operation for this electronic document include operations of saving, printing, rotating, searching for, and encrypting the electronic document, an operation of bundling two or more electronic documents, and the like. Further, the selection screen 430 is a screen for selecting an electronic document stored in a file corresponding to the tray icon 411a. The thumbnail image 440 is an image for confirming contents of the file before opening the file. The enlarged thumbnail image 450 is an enlarged image of the thumbnail image 440.

The selection screen 430 is a screen for selecting the electronic document stored in the file corresponding to the tray icon 411a, and is displayed in a state of being associated with the tray icon 411a. The selection screen 430 indicates, for example, a screen for selecting an electronic document stored in which file by adopting a balloon figure. Further, based on a position set by the user or a position at which the selected icon is displayed, the selection screen 430 is displayed at any of the top, bottom, left, and right positions with respect to the icon. In the present exemplary embodiment, a figure of the balloon is adopted for the selection screen 430, and the figure is not limited to this figure.

The thumbnail image 440 is displayed in a display area of the selection screen 430 by reducing an image of the electronic document stored in the file corresponding to the tray icon 411a. In the example illustrated in FIG. 2, the thumbnail image 440 for each of a plurality of document units is displayed (the six thumbnail images 440 in FIG. 2), and the representative thumbnail image 440 such as a first page is displayed in a state of being selectable by the user, for example.

The enlarged thumbnail image 450 is an enlarged image of one selected thumbnail image 440, and is displayed without starting a new program. The enlarged thumbnail image 450 is displayed while avoiding the tray icon 411a selected by the user and the display area of the selection screen 430. As a result, the icon and the thumbnail image selected by the user and the enlarged thumbnail image 450 are displayed at the same time. Further, it is assumed that the enlarged thumbnail image 450 is enlarged to a size that allows the user to understand contents of the thumbnail image. This size for understanding is set to be larger than the display of the thumbnail image 440 selected by the user.

Functional Configuration of Image Display Apparatus 1

Next, a functional configuration of the image display apparatus 1 will be described.

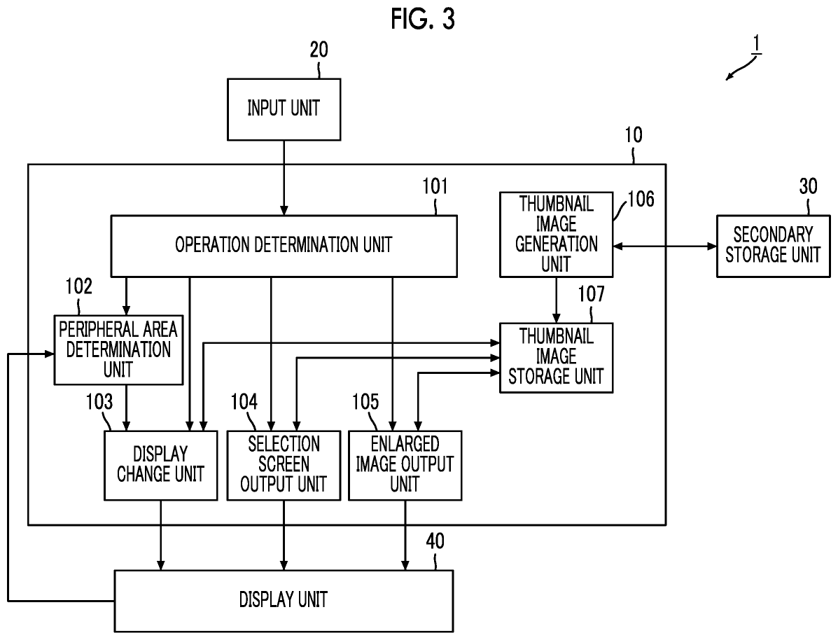

FIG. 3 is a block diagram illustrating an example of the functional configuration of the image display apparatus 1. The image display apparatus 1 includes an operation determination unit 101, a peripheral area determination unit 102, a display change unit 103, a selection screen output unit 104, an enlarged image output unit 105, a thumbnail image generation unit 106, and a thumbnail image storage unit 107, which are realized by the arithmetic processing unit 10 illustrated in FIG. 1.

The operation determination unit 101 determines whether or not there is a user operation on the operation screen 400 via the input unit 20. This “user operation” is, for example, an operation of selecting an icon or the like, an operation of moving an icon by dragging and dropping, or the like.

The peripheral area determination unit 102 determines information on a peripheral area, which is a peripheral area of the selected icon 410, based on the user operation determined by the operation determination unit 101 and the operation screen 400 displayed on the display unit 40. The peripheral area is an area, which is not superimposed on the selected icon, displayed in the display unit. The enlarged thumbnail image 450 illustrated in FIG. 2 is displayed in this “peripheral area”. More specifically, the peripheral area determination unit 102 performs determination, based on a size of the peripheral area in which the enlarged thumbnail image 450 is displayed and a display mode of the other icon 410 different from the selected icon 410 in the peripheral area and the toolbar 420.

The display change unit 103 changes the display mode or arrangement of the icon 410 and the toolbar 420, based on the information determined by the operation determination unit 101 or the peripheral area determination unit 102. Further, the thumbnail image 440 is obtained from the thumbnail image storage unit 107, which will be described below, and changed so that the icon 410 is displayed as the thumbnail image 440. As a case where the display of the operation screen 400 is required to be changed, the display change unit 103 has a case where there is no area for displaying the enlarged thumbnail image 450, a case where workability of the user is considered, and the like.

Based on the user operation determined by the operation determination unit 101, the selection screen output unit 104 obtains the thumbnail image 440 from the thumbnail image storage unit 107, which will be described below, and outputs the selection screen 430 and the thumbnail image 440 to the display unit 40. The selection screen 430 is displayed in a state of being associated with the selected icon 410. Preferably, the selection screen 430 is displayed at a position such as an end or the like of the operation screen 400 to secure an area for displaying the enlarged thumbnail image 450, for example.

The enlarged image output unit 105 takes out the thumbnail image 440 from the thumbnail image storage unit 107, which will be described below, based on the user operation determined by the operation determination unit 101. Further, the enlarged image output unit 105 outputs the enlarged thumbnail image 450 which is enlarged from the obtained thumbnail image 440, to the display unit 40, without starting a new program.

The thumbnail image generation unit 106 generates the thumbnail image 440 to be displayed on the operation screen 400, based on image data or the like stored in the secondary storage unit 30.

The thumbnail image storage unit 107 acquires and stores the thumbnail image 440 generated by the thumbnail image generation unit 106. The thumbnail image storage unit 107 is realized by the non-volatile memory 14.

Display Process of Enlarged Thumbnail Image

Next, a display process of the enlarged thumbnail image 450 will be described with reference to FIGS. 2 to 5B by using a case where the tray icon 411a is selected, as an example.

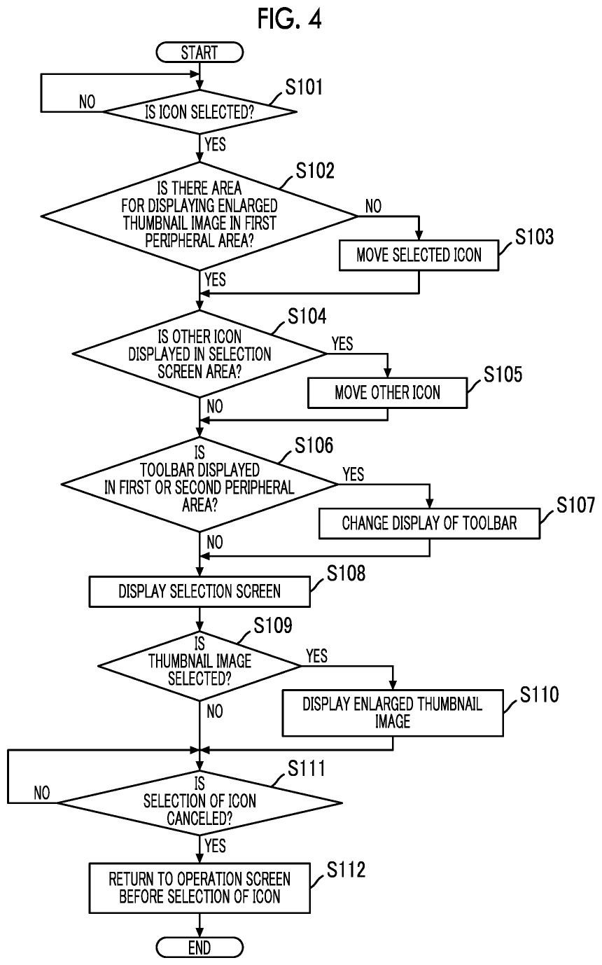

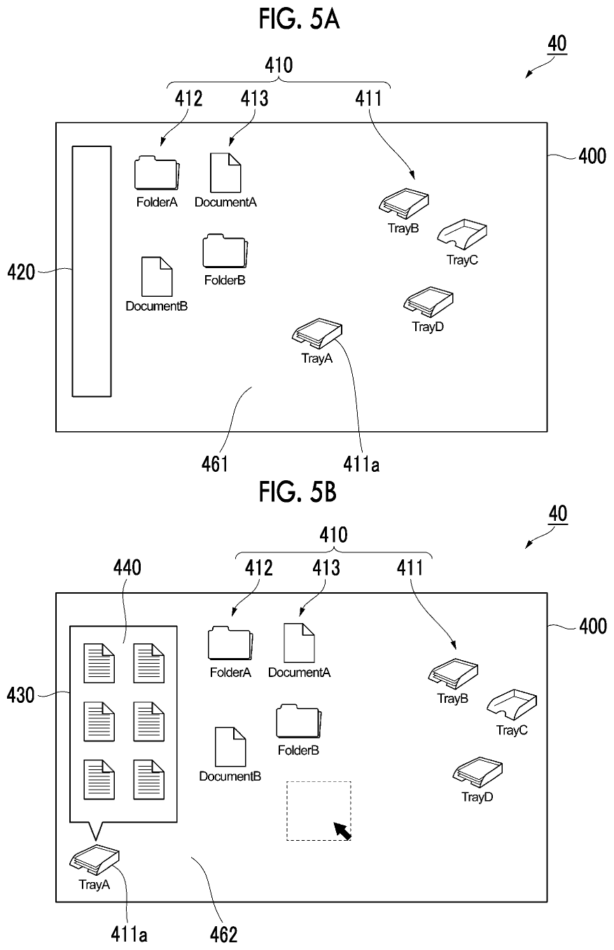

FIG. 4 is a flowchart illustrating a processing procedure of displaying the enlarged thumbnail image 450. In addition, FIGS. 5A and 5B are diagrams illustrating an example of displaying an operation screen. FIG. 5A illustrates an example of the operation screen 400 before an icon is selected, and FIG. 5B illustrates an example of displaying the selection screen 430 after the icon is selected.

The display unit 40 includes the operation screen 400 that displays the icon 410 that represents functions of various types of files with pictograms, as illustrated in FIGS. 5A and 5B. In the examples illustrated in FIGS. 5A and 5B, a tray icon 411, a folder icon 412, and an electronic document icon 413 are illustrated, as examples of the icon 410.

In the present exemplary embodiment, the tray icon 411, the folder icon 412, and the electronic document icon 413 are collectively referred to as the icon 410.

In addition to the icon 410, the toolbar 420, the selection screen 430, the thumbnail image 440, and the enlarged thumbnail image 450 are displayed on the operation screen 400. Further, in an area of the operation screen 400, a peripheral area of an icon displayed at a position accepted from the user is set to a first peripheral area 461, and a peripheral area of the icon displayed by moving from the position accepted from the user is set to a second peripheral area 462.

As illustrated in FIG. 5A, the icon 410 is displayed at a position accepted from the user, which is an area of the operation screen 400. For example, the user drags and drops one icon 410 to move the icon 410 to the position at which the one icon 410 is to be displayed. In addition, the user accepts settings such as a name or a color for each of the icons 410.

As illustrated in FIGS. 5A and 5B, the first peripheral area 461 and the second peripheral area 462 are areas of the operation screen 400, and are not superimposed on the display of the selected tray icon 411a.

In the flowchart illustrated in FIG. 4, first, the operation determination unit 101 illustrated in FIG. 3 determines whether or not the icon 410 is selected, based on an operation via the input unit 20 (step S101). In a case where the icon 410 is not selected (NO in step S101), the process waits until the icon 410 is selected. In a case where the icon 410 is selected in step S101 (YES in step S101), the peripheral area determination unit 102 determines whether or not there is an area for displaying the enlarged thumbnail image 450 in the first peripheral area 461 of the icon 410 (step S102). A determination condition includes, for example, an area ratio of the first peripheral area 461 having a rectangle shape to the operation screen 400, and a size of the first peripheral area 461 having the rectangle shape. Further, for example, in a case where the tray icon 411a in FIG. 5A is selected, a display position of the selected tray icon 411a affects the determination. In FIG. 5A, since the tray icon 411a is displayed near a center of the operation screen 400, an area of the first peripheral area 461 having the rectangle shape is less than half an area of the operation screen 400, so that it is determined that there is no area for displaying the enlarged thumbnail image 450 as it is.

In step S102, in a case where there is the area for displaying the enlarged thumbnail image 450 in the first peripheral area 461 (YES in step S102), the process proceeds to step S104. In step S102, in a case where there is no area for displaying the enlarged thumbnail image 450 in the first peripheral area 461 (NO in step S102), the display change unit 103 moves the icon 410 selected in step S101 (step S103). In the example in FIG. 5B, the selected tray icon 411a is moved to an end of the operation screen 400, and a peripheral area of the tray icon 411a becomes the second peripheral area 462 which is a peripheral area after the movement. Further, in a case where the selected icon 410 is moved from a position accepted by the user, the display change unit 103 can display that the selected icon 410 is displayed at the position accepted by the user. In the example in FIG. 5B, although the position at which the tray icon 411a is displayed before the movement is displayed by a dotted line. Alternatively, the position before movement may be displayed by a shade, an arrow, or the like, in addition to the dotted line display, as long as an original position of the icon instructed by the user can be recognized.

Next, the peripheral area determination unit 102 determines whether or not the other icon 410 different from the selected icon 410 is displayed in the display area of the selection screen 430 of the operation screen 400 (step S104). In the example in FIG. 5A, the folder icon 412 and the electronic document icon 413 are displayed in the display area of the selection screen 430 illustrated in FIG. 5B.

In step S104, in a case where the other icon 410 is not displayed in the display area of the selection screen 430 (NO in step S104), the process proceeds to step S106.

In a case where the other icon 410 is displayed in the display area of the selection screen 430 in step S104 (YES in step S104), the display change unit 103 moves the icon 410 displayed in the display area of the selection screen 430 (step S105). In the example in FIG. 5B, the folder icon 412 and the electronic document icon 413 are displayed while avoiding the selection screen 430. Further, in a case where there is no area for moving and displaying the folder icon 412 and the electronic document icon 413, the tray icon 411 different from the selected tray icon 411a may be moved.

Next, the peripheral area determination unit 102 determines whether or not the toolbar 420 is displayed in the first peripheral area 461 or the second peripheral area 462 on the operation screen 400 (step S106). In a case where the toolbar 420 is not displayed in the first peripheral area 461 or the second peripheral area 462 (NO in step S106), the process proceeds to step S108.

In step S106, in a case where the toolbar 420 is displayed in the first peripheral area 461 or the second peripheral area 462 (YES in step S106), the display change unit 103 changes the display of the toolbar 420 (step S107). In the example in FIG. 5B, the toolbar 420 is non-displayed so that the toolbar 420 is not displayed in the display area of the selection screen 430, which is an area of the second peripheral area 462. In addition to non-display, reduction, minimizing, change of display position, and the like may be performed.

The selection screen output unit 104 takes out the thumbnail image 440 corresponding to the icon 410 selected in step S101 from the thumbnail image storage unit 107, and outputs the selection screen 430 and the thumbnail image 440 to the display unit 40 (step S108). In the example in FIG. 5B, the selection screen 430 is displayed in a manner associated with the selected tray icon 411a, and the thumbnail image 440 is displayed for each of a plurality of document units.

The operation determination unit 101 determines whether or not one thumbnail image 440 is selected from a plurality of thumbnail images 440 displayed on the selection screen 430, based on an operation via the input unit 20 (step S109).

Ina case where the one thumbnail image 440 is not selected in step S109 (NO in step S109), the process proceeds to step S111.

In a case where the one thumbnail image 440 is selected instep S109 (YES instep S109), the enlarged image output unit 105 takes out the thumbnail image 440 from the thumbnail image storage unit 107, and outputs the enlarged thumbnail image 450 corresponding to the selected one thumbnail image 440 to the display unit 40, as illustrated in FIG. 2 (step S110). Examples of the operation for selecting the one thumbnail image 440 include an operation for a specific area of the one thumbnail image 440, mouse over, or the like. Further, in the example in FIG. 2, the toolbar 420 is displayed along a lower portion of the enlarged thumbnail image 450, and this configuration is not limited to this. The toolbar 420 maybe displayed along any side of the enlarged thumbnail image 450, or may be redisplayed at a position at which the toolbar 420 is displayed before the display of the toolbar 420 is changed. Alternatively, even in a case where the enlarged thumbnail image 450 is displayed, the display change of the toolbar 420 such as non-display or minimizing may be maintained.

The operation determination unit 101 determines whether or not the selection of the selected icon 410 is canceled, based on an operation via the input unit 20 (step S111). For example, in a case where the operation determination unit 101 accepts an operation such as reselection of the tray icon 411a illustrated in FIG. 2, an operation of a release button, or selection of the other icon 410 different from the tray icon 411a, the operation determination unit 101 determines that the selection of the tray icon 411a is canceled.

In a case where the selection of the selected icon 410 is not canceled in step S111 (NO in step S111), the process in step S111 is repeated.

In a case where the selected icon 410 is canceled in step S111 (YES in step S111), based on a release operation determined by the operation determination unit 101, the display change unit 103 returns to the operation screen 400 before the selection of the selected icon 410 (step S112), and the process is ended. In a case where the tray icon 411a is selected, for example, the process returns to the operation screen 400 before the selection of the tray icon 411a illustrated in FIG. 5A. That is, the change to the icon 410 or the toolbar 420 caused by the selection or the movement of the tray icon 411a is canceled.

Process of Moving Selection Screen

In the above example, the selected icon 410 is moved to display the selection screen 430, and the configuration is not limited to this.

As another example of the configuration, a process of displaying the selection screen 430 without moving the selected tray icon 411a will be described with reference to FIGS. 2, 3, 5A and 5B, and 6.

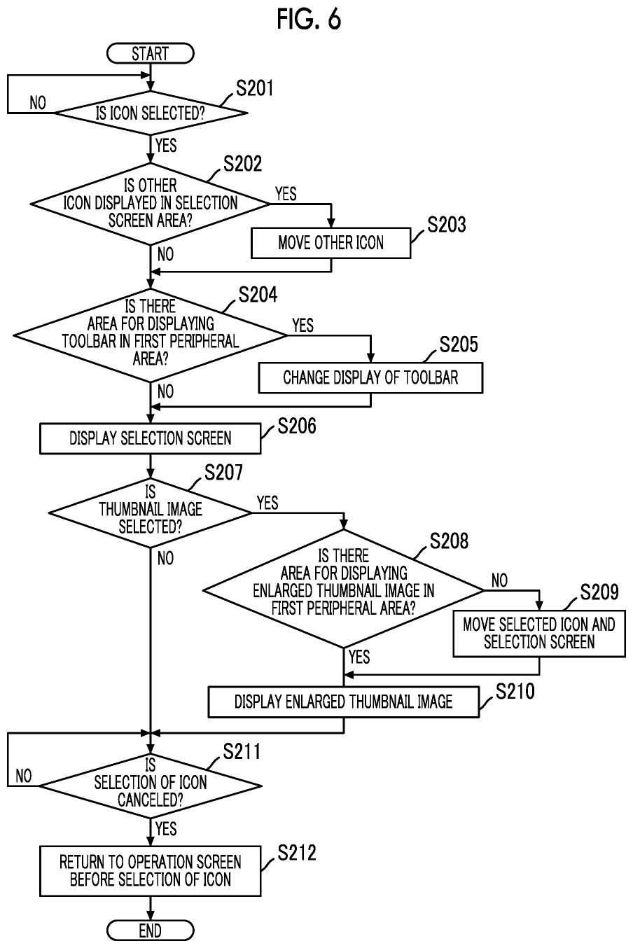

FIG. 6 is a flowchart illustrating a processing procedure of displaying a selection screen according to movement.

In the flowchart illustrated in FIG. 6, first, the operation determination unit 101 illustrated in FIG. 3 determines whether or not the icon 410 is selected, based on an operation via the input unit 20 (step S201). In a case where the icon 410 is not selected (NO in step S201), the process waits until the icon 410 is selected. In a case where the icon 410 is selected in step S201 (YES in step S201), the peripheral area determination unit 102 determines whether or not the other icon 410 different from the selected icon 410 is displayed in a display area of the selection screen 430 of the operation screen 400 (step S202). In the example in FIG. 5A, the folder icon 412 and the electronic document icon 413 are displayed in the display area of the selection screen 430 illustrated in FIG. 5B.

In step S202, in a case where the other icon 410 is not displayed in the display area of the selection screen 430 (NO in step S202), the process proceeds to step S204.

In a case where the other icon 410 is displayed in the display area of the selection screen 430 in step S202 (YES in step S202), the display change unit 103 moves the icon 410 displayed in the display area of the selection screen 430 (step S203).

Next, the peripheral area determination unit 102 determines whether or not the toolbar 420 is displayed in the first peripheral area 461, from the operation screen 400 (step S204).

In a case where the toolbar 420 is not displayed in the first peripheral area 461 (NO in step S204), the process proceeds to step S206.

In step S204, in a case where the toolbar 420 is displayed in the first peripheral area 461 (YES in step S204), the display change unit 103 changes the display of the toolbar 420 (step S205).

The selection screen output unit 104 takes out the thumbnail image 440 corresponding to the icon 410 selected in step S201 from the thumbnail image storage unit 107, and outputs the selection screen 430 and the thumbnail image 440 to the display unit 40 (step S206). In the example in FIG. 5B, the selection screen 430 is displayed at a left end of the operation screen 400, and the example is not limited to this. In a case where the tray icon 411a illustrated in FIG. 5A is selected, the selection screen 430 may be displayed in an area other than the left end of the operation screen 400, in a manner associated with the tray icon 411a.

The operation determination unit 101 determines whether or not one thumbnail image 440 is selected from the thumbnail images 440 displayed on the selection screen 430, based on an operation via the input unit 20 (step S207). In a case where the one thumbnail image 440 is not selected (NO in step S207), the process proceeds to step S211. In a case where the one thumbnail image 440 is selected in step S207 (YES in step S207), the peripheral area determination unit 102 determines whether or not there is an area for displaying the enlarged thumbnail image 450, in the first peripheral area 461 of the selected icon 410 (step S208). For example, in a case where the tray icon 411a in FIG. 5A is selected, the tray icon 411a is displayed near the center of the operation screen 400, so that an area of the first peripheral area 461 having the rectangle shape is less than half an area of the operation screen 400 and it is determined that there is no area for displaying the enlarged thumbnail image 450 as it is.

In step S208, in a case where there is the area for displaying the enlarged thumbnail image 450 in the first peripheral area 461 (YES in step S208), the process proceeds to step S210.

In step S208, in a case where there is no area for displaying the enlarged thumbnail image 450 in the first peripheral area 461 (NO in step S208), the display change unit 103 moves the selected icon 410 and the selection screen 430 (step S209). In the example in FIG. 2, the selected tray icon 411a and the selection screen 430 move to the end of the operation screen 400.

The enlarged image output unit 105 takes out the one thumbnail image 440 from the thumbnail image storage unit 107, and outputs the enlarged thumbnail image 450 corresponding to the one thumbnail image 440 to the display unit 40 as illustrated in FIG. 2 (step S210).

The operation determination unit 101 determines whether or not the selection of the selected icon 410 is canceled, based on an operation via the input unit 20 (step S211). In a case where the selected icon 410 is not canceled (NO in step S211), the process in step S211 is repeated. In a case where the selected icon 410 is canceled in step S211 (YES in step S211), based on a release operation determined by the operation determination unit 101, the display change unit 103 returns to the operation screen 400 before the selection of the selected icon 410 (step S212), and the process is ended. In a case where the tray icon 411a is selected, for example, the process returns to the operation screen 400 before the selection of the tray icon 411a illustrated in FIG. 5A. That is, the change to the icon 410 or the toolbar 420 caused by the selection of the icon 410 and the movement of the icon 410 or the selection screen 430 is canceled.

The enlarged thumbnail image 450 may not be needed in a case where the user confirms what electronic documents are stored in a specific file. In the process of moving the selection screen 430 described above, the selected icon 410 and the selection screen 430 are not moved before the user requests the enlarged thumbnail image 450. As a result, a frequency of changing the display of the operation screen 400 is reduced, as compared with the process as illustrated in FIG. 4.

Process of Not Display Selection Screen

In the above example, the selection screen 430 is displayed, and the configuration is not limited to this.

As another example, a process of displaying the enlarged thumbnail image 450 in a case where the tray icon 411a is selected will be described with reference to FIGS. 2, 3, 5A and 5B, and 7.

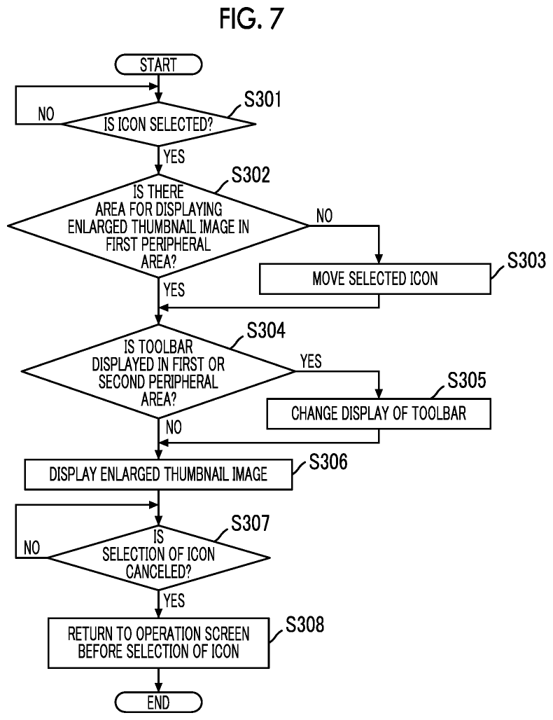

FIG. 7 is a flowchart illustrating a processing procedure of displaying an enlarged thumbnail image without displaying a selection screen.

In the flowchart illustrated in FIG. 7, first, the operation determination unit 101 illustrated in FIG. 3 determines whether or not the icon 410 is selected, based on an operation via the input unit 20 (step S301). In a case where the icon 410 is not selected (NO in step S301), the process waits until the icon 410 is selected. In a case where the icon 410 is selected in step S301 (YES in step S301), the peripheral area determination unit 102 determines whether or not there is an area for displaying the enlarged thumbnail image 450 in the first peripheral area 461 of the selected icon 410 (step S302). Further, for example, in a case where the tray icon 411a in FIG. 5A is selected, the tray icon 411a is displayed near the center of the operation screen 400, so that an area of the first peripheral area 461 having the rectangle shape is less than half an area of the operation screen 400 and it is determined that there is no area for displaying the enlarged thumbnail image 450 as it is.

In step S302, in a case where there is the area for displaying the enlarged thumbnail image 450 in the first peripheral area 461 (YES in step S302), the process proceeds to step S304.

In step S302, in a case where there is no area for displaying the enlarged thumbnail image 450 in the first peripheral area 461 (NO in step S302), the display change unit 103 moves the icon 410 selected in step S301 (step S303). In the example in FIG. 5B, the selected tray icon 411a is moved to an end of the operation screen 400, and a peripheral area of the tray icon 411a becomes the second peripheral area 462 which is a peripheral area after the movement.

Next, the peripheral area determination unit 102 determines whether or not the toolbar 420 is displayed in the first peripheral area 461 or the second peripheral area 462 of the operation screen 400 (step S304). In a case where the toolbar 420 is not displayed in the first peripheral area 461 or the second peripheral area 462 (NO in step S304), the process proceeds to step S306. In step S304, in a case where the toolbar 420 is displayed in the first peripheral area 461 or the second peripheral area 462 (YES instep S304), the display change unit 103 changes the display of the toolbar 420 (step S305). As illustrated in FIG. 2, a display position or the like of the toolbar 420 is changed so that the toolbar 420 is not displayed in an area in which the enlarged thumbnail image 450 is displayed, which an area of the first peripheral area 461 or the second peripheral area 462.

Next, the enlarged image output unit 105 takes out the thumbnail image 440 corresponding to the icon 410 selected from the thumbnail image storage unit 107, and outputs the enlarged thumbnail image 450 to the display unit 40 (step S306). The enlarged image output unit 105 outputs the enlarged thumbnail image 450 which is enlarged from the representative thumbnail image 440, among the electronic documents stored in the file corresponding to the selected icon 410. The enlarged image output unit 105 outputs, for example, the enlarged thumbnail image 450 which is enlarged from the representative thumbnail image 440 such as a first page of the most recently stored electronic document, among the electronic documents stored in the file corresponding to the selected tray icon 411a.

The operation determination unit 101 determines whether or not the selection of the selected icon 410 is canceled, based on an operation via the input unit 20 (step S307). In a case where the selected icon 410 is not canceled (NO in step S307), the process in step S307 is repeated. In a case where the selected icon 410 is canceled in step S307 (YES in step S307), based on a release operation determined by the operation determination unit 101, the display change unit 103 returns to the operation screen 400 before the selection of the selected icon 410 (step S308), and the process is ended. The change to the icon 410 or the toolbar 420 caused by the selection or the movement of the icon 410 is canceled, and the display returns to the operation screen 400 illustrated in FIG. 5A.

In a case where the user confirms what electronic documents are stored in a specific file, the user may need to confirm one electronic document. In the process of displaying the selection screen 430 described above, the enlarged thumbnail image 450 is not displayed unless any one of the thumbnail images 440 is selected by the user. In a case where a file is selected, the number of instructions by the user is reduced by displaying the enlarged thumbnail image 450 of one electronic document stored in the selected file.

Setting Related to Display of Enlarged Thumbnail Image or Like

Further, in the above example, the display of the operation screen 400 is automatically changed according to the display of the enlarged thumbnail image 450, based on the user operation, and the display may be changed based on an instruction by the user.

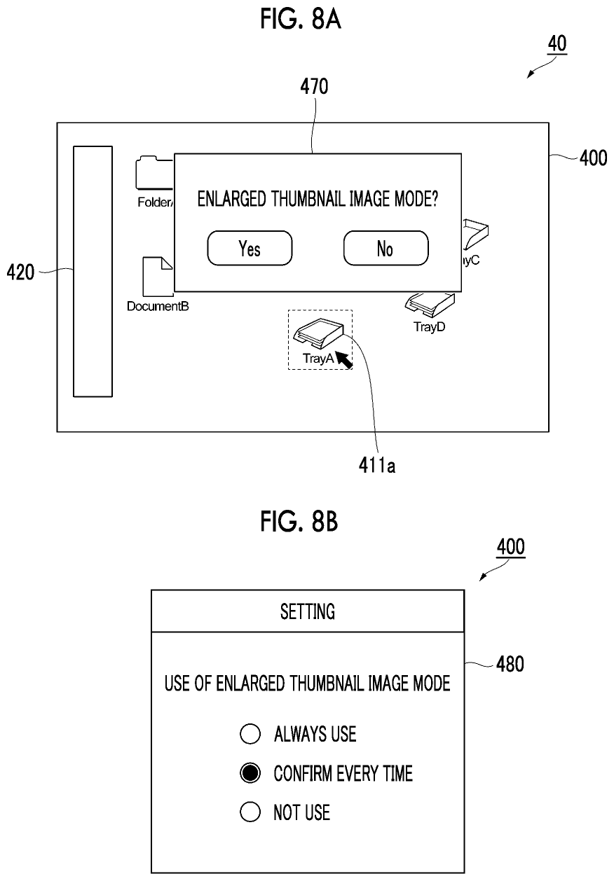

As another example, a screen on which the user can determine whether or not to move the selected icon 410 will be described with reference to FIGS. 8A and 8B.

FIGS. 8A and 8B are diagrams illustrating an example of a screen for requesting an instruction to a user.

On the operation screen 400 illustrated in FIG. 5A, for example, in a case where the tray icon 411a is selected, as illustrated in FIG. 8A, a confirmation screen 470 for asking the user “Enlarged thumbnail image mode?” is displayed. Here, the “enlarged thumbnail image mode” is a process of moving the tray icon 411a in order to secure an area for displaying the enlarged thumbnail image 450. As a result, the user accepts an instruction as to whether or not to move the tray icon 411a.

Further, in the example illustrated in FIG. 8A, the enlarged thumbnail image mode is confirmed after the icon 410 is selected, and it is not necessary to confirm each time the icon 410 is selected.

Before any of the icons 410 of the operation screen 400 is selected, as illustrated in FIG. 8B, a setting screen 480 preset by the user regarding a use of the enlarged thumbnail image mode is displayed. The setting screen 480 is displayed, for example, in a case where an icon related to a setting (not illustrated) on the operation screen 400 is operated, or in a case where software for providing the operation screen 400 is used for the first time. The user instructs the setting such as “always use”, “confirm every time”, and “not use” in the enlarged thumbnail image mode. In a case where the user presets “confirm every time”, the confirmation screen 470 is displayed after any of the icons 410 is selected.

Further, although the setting screen 480 is displayed before any of the icons 410 is selected, the setting screen 480 may be displayed in a case where the icon 410 is selected for the first time by the user.

In the examples illustrated in FIGS. 8A and 8B, the instruction as to whether or not to use the enlarged thumbnail image mode is accepted, and an instruction such as a position at which the selected icon 410 is to be moved, a movement mode of the icon 410, a display mode of the toolbar 420, or the like may be accepted.

Regarding the position at which the selected icon 410 is to be moved, instructions such as upper, lower, left, and right of the operation screen 400 are accepted. Further, regarding the movement mode of the icon 410, instructions such as whether to move the icon 410 by animation or to instantly change the displayed position are accepted. Further, regarding the display mode of the toolbar 420, instructions such as non-displaying, minimizing, reducing the toolbar 420, redisplaying the toolbar 420 in a case where the enlarged thumbnail image is displayed, and a position of the redisplaying are accepted. Further, in a case where the toolbar 420 is reduced or redisplayed, an instruction unit that is permitted to be used by the user at that time or an instruction unit selected by the user may be displayed.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a processor configured to:
in a case where an image related to a file or a thumbnail image corresponding to the file is selected and an enlarged thumbnail image obtained by enlarging the thumbnail image is displayed in a first peripheral area which is a peripheral area of the image related to the file or the thumbnail image,
move the image related to the file or the thumbnail image in a case where the first peripheral area is smaller than a predetermined value; and
display the enlarged thumbnail image in a second peripheral area which is a peripheral area of the image related to the file or the thumbnail image after the movement.

2. The information processing apparatus according to claim 1, wherein the processor is configured to:
in a case where the image related to the file or the thumbnail image is selected, move the image related to the file or the thumbnail image.

3. The information processing apparatus according to claim 1, wherein the processor is configured to:
accept a position at which the image related to the file or the thumbnail image is to be displayed from a user,
display the image or the thumbnail image at the accepted position, and
in a case where the enlarged thumbnail image is displayed, move the image related to the file or the thumbnail image from the position.

4. The information processing apparatus according to claim 3, wherein the processor is configured to:
display that the image related to the file or the thumbnail image is displayed at the position.

5. The information processing apparatus according to claim 3, wherein the processor is configured to:
in a case where the selection of the image related to the file or the thumbnail image is canceled, move the image related to the file or the thumbnail image to the position.

6. The information processing apparatus according to claim 1,
wherein the thumbnail image is displayed in a selection screen area which is an area for displaying the thumbnail image, in a state of being associated with the image related to the file selected by a user.

7. The information processing apparatus according to claim 6, wherein the processor is configured to:
display an image related to another file different from the image related to the file selected by the user while avoiding the selection screen area.

8. The information processing apparatus according to claim 6, wherein the processor is configured to:
in a case where the thumbnail image is selected, move the selection screen area.

9. The information processing apparatus according to claim 1, wherein the processor is configured to:
display an aggregation of instruction units that accept instructions from a user, and
in a case where the user selects the image related to the file or the thumbnail image, change the display of the aggregation of the instruction units displayed in the second peripheral area.

10. The information processing apparatus according to claim 9, wherein the processor is configured to:
in a case where the user selects the image related to the file, reduce the display of the aggregation of the instruction units or not display the aggregation of the instruction units.

11. The information processing apparatus according to claim 10, wherein the processor is configured to:
in a case where the user selects the file, move the aggregation of the instruction units according to the display of the enlarged thumbnail image.

12. A non-transitory computer readable medium storing a program causing a computer to realize:
in a case where an image related to a file or a thumbnail image corresponding to the file is selected and an enlarged thumbnail image obtained by enlarging the thumbnail image is displayed in a first peripheral area which is a peripheral area of the image related to the file or the thumbnail image,
a function of moving, in a case where the first peripheral area is smaller than a predetermined value, the image related to the file or the thumbnail image; and
a function of displaying the enlarged thumbnail image in a second peripheral area which is a peripheral area of the image related to the file or the thumbnail image after the movement.

13. An information processing method comprising:
in a case where an image related to a file or a thumbnail image corresponding to the file is selected and an enlarged thumbnail image obtained by enlarging the thumbnail image is displayed in a first peripheral area which is a peripheral area of the image related to the file or the thumbnail image,
moving, in a case where the first peripheral area is smaller than a predetermined value, the image related to the file or the thumbnail image; and
displaying the enlarged thumbnail image in a second peripheral area which is a peripheral area of the image related to the file or the thumbnail image after the movement.
